(19) United States
(12) Patent Application Publication
(10) Pub. No.: US 2004/0160185 A1
(43) Pub. Date: Aug. 19, 2004

(54) Plasma display panel comprising ultraviolet-to-visible ray converter

(75) Inventors: Hidekazu Hatanaka, Gyeonggi-do (KR); Gi-young Kim, Chungcheongbuk-do (KR); Seung-hyun Son, Gyeonggi-do (KR); Kyung-jun Hong, Jeollanam-do (KR)

Correspondence Address: BURNS DOANE SWECKER & MATHIS L L P, POST OFFICE BOX 1404, ALEXANDRIA, VA, 22313-1404, US

(73) Assignee: Samsung SDI Co., Ltd., Suwon-si (KR)

(21) Appl. No.: 10/769,845

(22) Filed: Feb. 3, 2004

(30) Foreign Application Priority Data
Feb. 14, 2003 (KR) 10-2003-0009414

(51) Int. Cl. H01J 17/49

(52) U.S. Cl. 313/582; 313/586; 313/587; 313/486

(57) ABSTRACT

A plasma display panel (PDP) comprising an ultraviolet-to-visible rays converter is provided. The plasma display panel includes a front panel, a rear panel, a filter set, and an optical converter. The filter set is installed in front of the front panel. The optical converter is installed between the front panel and the filter set and converts ultraviolet rays emitted from the front panel into visible rays. Accordingly, the ultraviolet rays emitted from a plasma forming area in a discharge cell are mostly converted into visible rays. Therefore, the efficiency of the PDP is naturally improved.

This application claims the priority of Korean Patent Application No. 2003-9414, filed on Feb. 14, 2003, in the Korean Intellectual Property Office, the disclosure of which is incorporated herein in its entirety by reference.

### BACKGROUND OF THE INVENTION

1. Field of the Invention

The present invention relates to planar display devices, and more particularly, to a plasma display panel (hereinafter, referred to as PDP) comprising an ultraviolet-to-visible ray converter.

2. Description of the Related Art

PDPs are planar image display devices, in which a gas, such as Ne+Xe, is injected into a space that is defined by a front glass substrate, a rear glass substrate, and partitions between the front and rear glass substrates, ultraviolet (UV) rays emitted from Xe gas due to application of a voltage to anodes and cathodes are converted into visible rays by using fluorescent substances, and the visible rays are used as display rays.

PDPs can be the most easily enlarged, among planar displays, such as liquid crystal displays (LCDs), field emission displays (FEDs), and electro-luminescence displays (ELDs).

PDPs are anticipated to have a high luminance and a high luminous efficacy, by plasma production due to the employment of an efficient electrode structure and an efficient driving circuit, by an improvement in the efficiency of UV emission from plasma, by an improvement in the efficiency of conversion of visible rays by fluorescent substances, and by other measures.

FIG. 1 is an exploded perspective view of a conventional AC type PDP. Referring to FIG. 1, the conventional AC type PDP includes a front glass substrate 10 and a rear glass substrate 12, which faces the front glass substrate 10 in parallel. A filter set 30 is installed over the front glass substrate 10 and blocks off infrared rays (IR), electromagnetic interference (EMI), and the like that are emitted from the PDP. The filter set 30 is comprised of black stripe areas 32a and filtering areas 32b. The filtering areas 32b receive and filter out filtering elements, such as, IR or EMI generated from discharge cells. The black stripe areas 32a correspond to barrier ribs 26 to be described later, in a one-to-one correspondence, and prevent the filtering elements generated from a discharge cell from being introduced into another discharge cell. First and second discharge sustaining electrodes 14a and 14b are arranged in parallel on a surface of the front glass substrate 10 that faces the rear glass substrate 12. The first and second discharge sustaining electrodes 14a and 14b are transparent. As shown in FIG. 2, there is a gap (d) between the first and second discharge sustaining electrodes 14a and 14b. A first bus electrode 16a is formed on the first discharge sustaining electrode 14a, and a second bus electrode 16b is formed on the second discharge sustaining electrode 14b. The first and second bus electrodes 16a and 16b prevent a voltage from being lowered by a resistance during discharge. The first and second discharge sustaining electrodes 14a and 14b and the first and second bus electrodes 16a and 16b are covered with a first dielectric layer 18, which is covered with a protective film 20. The protective film 20 protects the first dielectric layer 18, which is weak to discharge, so that the PDP can stably operate for a long period of time. Also, the protective film 20 lowers a discharge voltage by emitting secondary electrons in great quantities during discharge. A magnesium oxide (MgO) film is widely used as the protective film 20.

Address electrodes 22 for addressing pixels are installed on the rear glass substrate 12. Since one address electrode 22 is included in one discharge cell, one pixel has three address electrodes 22. The address electrodes 22 are parallel to one another and perpendicular to the first and second discharge sustaining electrodes 14a and 14b. A second dielectric layer 24, with which the address electrodes 22 are covered, is formed on the rear glass substrate 12 and performs a light reflection. A plurality of barrier ribs 26 are arranged at regular intervals on the second dielectric layer 24. More specifically, the barrier ribs 26 are placed on portions of the second dielectric layer 24 that exist between adjacent address electrodes 22. From the viewpoint of the second dielectric layer 24, the address electrodes 22 alternate with the barrier ribs 26. The barrier ribs 26 adhere to the protective film 20 on the front glass substrate 10 while the front and rear glass substrates 10 and 12 are joining. Fluorescent layers 28a, 28b, and 28c are coated between adjacent barrier ribs 26 such as to cover the portions of the second dielectric layer 24 defined therebetween and lateral surfaces of the barrier ribs 26. The first, second, and third fluorescent layers 28a, 28b, and 28c are excited by UV rays and thus emit red (R), green (G), and blue (B) light, respectively.

FIG. 3 is a cross-section of a unit discharge cell of the PDP, taken in a direction perpendicular to the address electrodes 22. In FIG. 3, reference character A1 denotes UV rays with 147 nm and 173 nm wavelengths that are emitted from a plasma forming area 32 and projected toward the fluorescent layers 28a, 28b, and 28c. The rays A1 are referred to as first UV rays hereinafter. Reference character A2 denotes visible rays emitted from the fluorescent layers 28a, 28b, and 28c excited by the first UV rays A1, while the fluorescent layers are being stabilized. Reference character A3 denotes UV rays with 147 nm and 173 nm wavelengths that are emitted in the direction opposite to the direction of emission of the first UV rays A1. The rays A3 are referred to as second UV rays hereinafter.

As shown in FIG. 3, in a conventional PDP, some of the UV rays emitted from the plasma forming area 32 within a cell, that is, the second UV rays A3, are absorbed by the front glass substrate 10. In other words, in a conventional PDP, the fluorescent layers 28a, 28b, and 28c are excited not by most of the UV rays emitted from the plasma forming area 32 but by only some of the UV rays.

The visible rays emitted from the fluorescent layers 28a, 28b, and 28c increase in proportion to the number of UV rays projected onto the fluorescent layers 28a, 28b, and 28c. As described above, in a conventional PDP, since the number of UV rays projected onto the fluorescent layers 28a, 28b, and 28c is restricted, the number of visible rays emitted from the fluorescent layers 28a, 28b, and 28c is also restricted. As a result, the luminance and efficiency of a conventional PDP are lowered.

### SUMMARY OF THE INVENTION

The present invention provides a PDP that can use UV rays emitted from a cell in order to improve the luminance.

According to an aspect of the present invention, there is provided a plasma display panel including a front panel, a rear panel, and a filter set which is installed in front of the front panel. The plasma display panel also includes an optical converter which is installed between the front panel and the filter set and converts ultraviolet rays emitted from the front panel into visible rays.

The optical converter is attached to a front surface of the front panel or the back of the filter set. The optical converter is a fluorescent plate having a predetermined thickness.

Preferably, the fluorescent plate is formed of a fluorescent material that is able to convert ultraviolet rays with a wavelength of more than 330 nm into visible rays.

It is preferable that the fluorescent plate has a thickness that enables the amount of visible rays emitted from the front panel to be greater than the amount of visible rays lost while passing through the fluorescent plate.

The fluorescent plate is formed by combining red, green, and blue fluorescent plates that emit red, green, and blue visible rays, respectively, into which the ultraviolet rays are converted.

When the thickness of the fluorescent plate is t, the thickness of the red fluorescent plate is in the range of 0 μm<t<35 μm, preferably, in the range of 5 μm≦t<35 μm, the thickness of the green fluorescent plate is in the range of 0 μm<t<36 μm, preferably, in the range of 5 μm≦t<36 μm, and the thickness of the blue fluorescent plate is in the range of 0 μm<t<37 μm, preferably, in the range of 5 μm≦t<37 μm. The thickness of each of the red, green, and blue fluorescent films may be identical to or different from one another.

The red fluorescent plate is an Y₂O₂S:Eu plate, and the green and blue fluorescent plates are BAM plates.

A plasma source gas that emits ultraviolet rays with a wavelength of more then 330 nm exists in a discharge region between the front and rear panels, and a side of the rear panel that is exposed to the discharge region is covered with a fluorescent film that is excited by the ultraviolet rays and emits visible rays.

Accordingly, the ultraviolet rays emitted from a plasma forming area in a discharge cell are mostly converted into visible rays. Therefore, the efficiency of the PDP is naturally improved.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a conventional AC type PDP;

FIG. 2 is a perspective view of the discharge sustaining electrodes and the bus electrodes shown in FIG. 1;

FIG. 3 is a cross-section of the PDP of FIG. 1, taken in a direction perpendicular to the bus electrodes;

FIG. 4 is an exploded perspective view of a PDP according to an embodiment of the present invention which includes an optical converter between a filter set and a front panel;

FIG. 5 is a partial cross-section of the PDP of FIG. 4, taken in the direction perpendicular to the address electrodes of FIG. 4;

FIG. 6 is a graph showing a second positive band spectrum of a nitrogen gas used as a source gas for forming plasma on the PDP of FIG. 4;

FIG. 7 is a graph showing a light transmittance of a front panel and a light transmittance of a front glass substrate of the PDP of FIG. 4;

FIG. 8 is a graph showing an excitation curve of the second/third fluorescent plate excited by UV rays;

FIG. 9 is a graph showing an excitation curve of the first fluorescent plate excited by UV rays;

FIG. 10 is a graph showing a transmittance of green (G) light versus the thickness of an optical converter; and

FIGS. 11 and 12 are cross-sections of modifications of the PDP of FIG. 5.

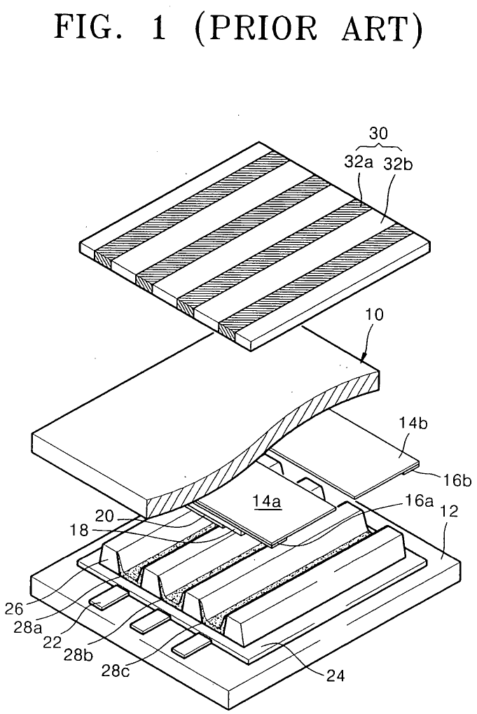

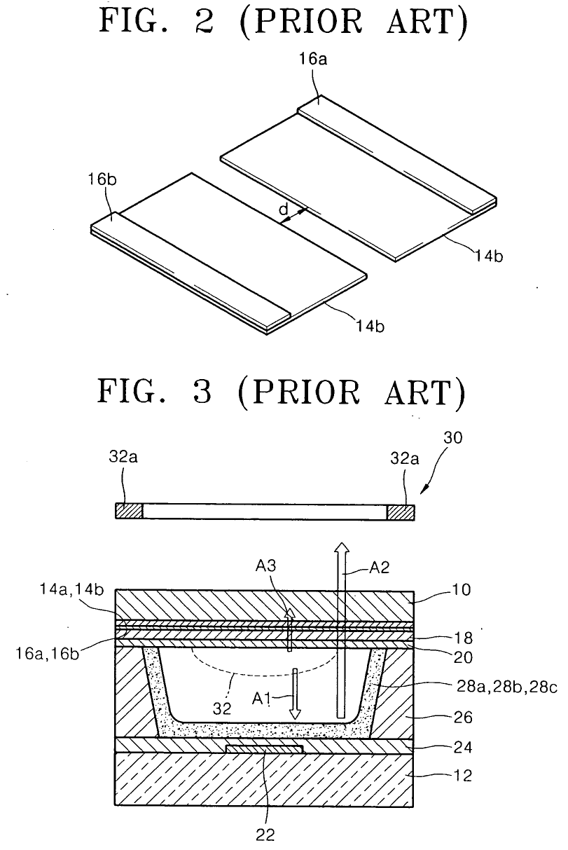

### DETAILED DESCRIPTION OF THE INVENTION

A PDP according to an embodiment of the present invention will now be described with reference to the accompanying drawings. In the drawings, the thicknesses of shown layers or regions are exaggerated for the clarity of the specification.

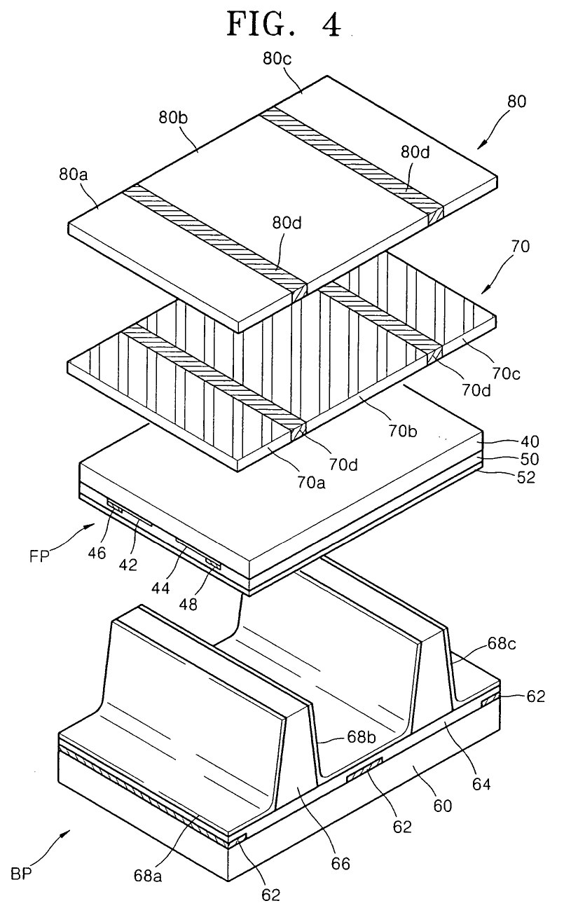

Referring to FIG. 4, a PDP according to an embodiment of the present invention includes a front panel FP, a rear panel BP, an optical converter 70, and a filter set 80. The front and rear panels FP and BP face each other, and the optical converter 70 and the filter set 80 are installed over the front panel FP.

The front panel FP includes a front glass substrate 40, first and second discharge sustaining electrodes 42 and 44, first and second bus electrodes 46 and 48, a first dielectric layer 50, and a protective film 52. The front glass substrate 40 includes a first side, which faces a user, and a second side, which faces the rear panel BP. The first and second discharge sustaining electrodes 42 and 44 are formed on the second side of the front glass substrate 40 so that they are parallel to each other and isolated from each other. The first and second bus electrodes 46 and 48 are formed parallel to and on the first and second discharge sustaining electrodes 42 and 44, respectively. The first dielectric film 50 is formed on the second side of the front glass substrate 40 while covering the first and second bus electrodes 46 and 48 and the first and second discharge sustaining electrodes 42 and 44. The first dielectric layer 50 has a flat surface. The protective film 52 is formed on the surface of the first dielectric film 50.

The rear panel BP includes a rear glass substrate 60, address electrodes 62, a second dielectric layer 64, barrier ribs 66, and first through third fluorescent layers 68a, 68b, and 68c. The rear glass substrate 60 has a uniform thickness and has a third side, which faces the front panel FP, and a fourth side, which faces the opposite direction of the front panel FP. The address electrodes 62 are formed in parallel to one another on the third side of the rear glass substrate 60 at predetermined intervals. The second dielectric layer 64 is formed on the third side of the rear glass substrate 60 and has a flat surface. The address electrodes 62 are covered with the second dielectric layer 64. The barrier ribs 66 are formed in strips on portions of the second dielectric layer 64 that exist between adjacent address electrodes 62, so as to be parallel to the address electrodes 62. The barrier ribs 66 are formed to a predetermined height. The height of the barrier ribs 66 is an important factor that determines the interval between the barrier ribs 66 and a discharge cell region of a PDP. Two barrier ribs 66 define a discharge cell. Because one address electrode 62 is formed on the portion of the second dielectric layer 64 between barrier ribs 66, the numbers of address electrodes 62 and discharge cells included in the PDP are the same. The first, second, and third fluorescent layers 68a, 68b, and 68c are included in three discharge cells, respectively, that form a pixel unit. The first, second, and third fluorescent layers 68a, 68b, and 68c are coated on a surface of the second dielectric layer 64 between adjacent barrier ribs 66 and facing side surfaces of the barrier ribs 66, are excited by UV rays, and emit red (R), green (G), and blue (B) rays during stabilization. The first, second, and third fluorescent layers 68a, 68b, and 68c are excited by UV rays with wavelengths of at least 330 nm. Preferably, the first fluorescent layer 68a is an Y₂O₂S:Eu layer that emits R rays by being excited by UV rays, the second fluorescent layer 68b is a BAM(BaAl₁₂O₁₉:Mn) layer that emits G rays, and the third fluorescent layer 68c is a BAM(BaMgAl₁₀O₁₇:Eu) layer that emits B rays.

When the first, second, and third fluorescent layers 68a, 68b, and 68c are excited by UV rays with a wavelength of 330 nm or greater, the stokes efficiency of fluorescent substances is nearly double the stokes efficiency in the prior art when UV rays with a wavelength of 147 nm is used. Also, the transmittance with respect to the front panel FP increases.

Some of the UV rays produced in a discharge region of a PDP are directed upward the discharge region and penetrate the front panel FP. The optical converter 70 converts the UV rays transmitted by the front panel FP into visible rays to thus increase the luminance and luminous efficacy of the PDP. For example, the optical converter 70 can be a fluorescent plate that is composed of first, second, third fluorescent plates 70a, 70b, and 70c and first black strips 70d. The first, second, third fluorescent plates 70a, 70b, and 70c correspond to three discharge cells with the first, second, and third fluorescent layers 68a, 68b, and 68c, respectively. The first black strips 70d are formed between adjacent fluorescent plates of the first, second, and third fluorescent plates 70a, 70b, and 70c and correspond to the barrier ribs 66. The first black strips 70d prevent electronic wave interface between adjacent discharge cells, that is, UV rays or visible rays.

Since the first, second, and third fluorescent plates 70a, 70b, and 70c are supposed to convert UV rays emitted from a discharge region into visible rays, it is preferable that they are easily excited by the UV rays so as to emit visible rays. Also, because the first, second, and third fluorescent plates 70a, 70b, and 70c correspond to three discharge cells with the first, second, and third fluorescent layers 68a, 68b, and 68c, respectively, it is preferable that the first, second, and third fluorescent plates 70a, 70b, and 70c are formed of fluorescent materials that emit R, G, and B rays, respectively. Accordingly, it is more desirable that the first, second, and third fluorescent plates 70a, 70b, and 70c are formed of the fluorescent materials for the first, second, and third fluorescent layers 68a, 68b, and 68c. However, the first, second, and third fluorescent plates 70a, 70b, and 70c may be formed of other fluorescent materials. That is to say, the first fluorescent plate 70a is preferably a Y₂O₂S:Eu plate, and the second and third fluorescent plates 70b and 70c are preferably BAM plates. However, the first, second, and third fluorescent plates 70a, 70b, and 70c may be any fluorescent plates that can emit R, G, and B rays by UV rays with a wavelength of more than 330 nm, for example, organic photo-luminescent material dye plates. The optical converter 70 may be a film or powder, which will be described later.

The filter set 80 installed in front of the optical converter 70 is comprised of first, second, and third filters 80a, 80b, and 80c and second black strips 80d and blocks off the hazardous waves emitted from the above elements. The first, second, and third filters 80a, 80b, and 80c are located so as to face the first, second, and third fluorescent plates 70a, 70b, and 70c, and the second black strips 80d are located so as to face the first black strips 70d.

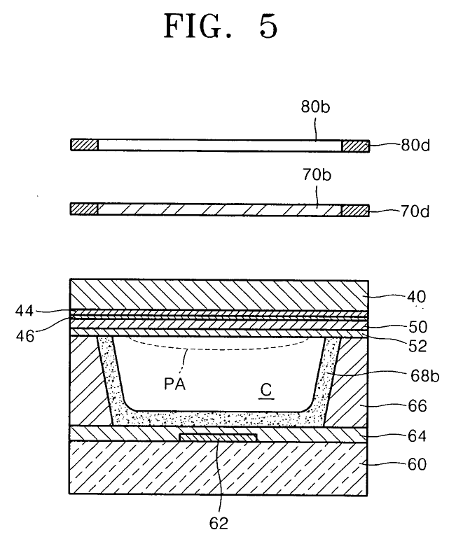

FIG. 5 is a partial cross-section of the PDP of FIG. 4, taken in the direction perpendicular to the address electrodes 62. A cross-section of a discharge cell C having the second fluorescent layer 68b is shown in FIG. 5. In FIG. 5, reference character PA denotes an area for forming plasma. Because the plasma forming area PA is shown for convenience' sake, it must not be interpreted as being restricted as shown in FIG. 5.

PDPs according to other embodiments of the present invention will be described later with reference to FIG. 5. Hence, the contents of FIG. 5 are equally applied to the first and third fluorescent layers 68a and 68c.

Although not shown in FIG. 5, the discharge cell C is filled with a source gas for forming plasma. The source gas may be a gas that can emit UV rays with wavelengths of more than 330 nm during the formation of plasma, for example, a nitrogen (N₂) gas, a Xenon Fluoride (XeF*) gas, or the like. Preferably, the N₂ gas is used as the source gas. When the N₂ gas is used as the source gas, it is desirable that a proper amount of additional gas is used together with the N₂ gas. Preferable examples of the additional gas include a helium (He) gas, a neon (Ne) gas, an argon (Ar) gas, a krypton (Kr) gas, or a zenon (Xe) gas.

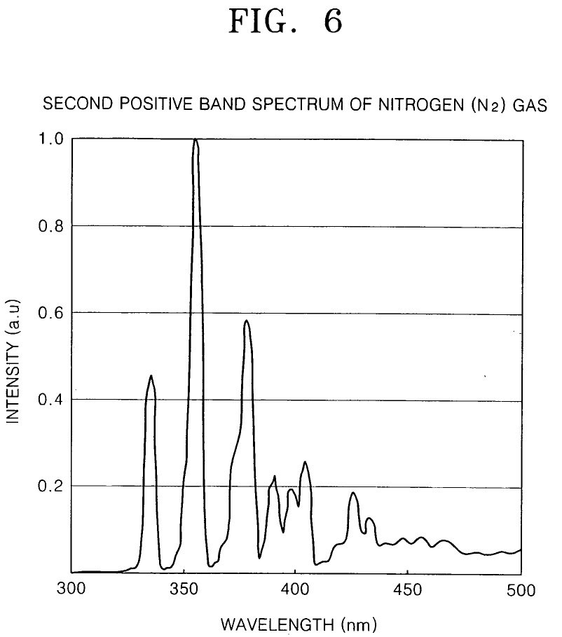

FIG. 6 shows a second positive band spectrum of a N₂ gas. It can be seen from FIG. 6 that a N₂ gas has distinct intensities at 337 nm, 358 nm, and 381 nm wavelengths. Hence, when the N₂ gas is used as the source gas, UV rays with three wavelengths of more than 330 nm are emitted from the source gas during the formation of plasma.

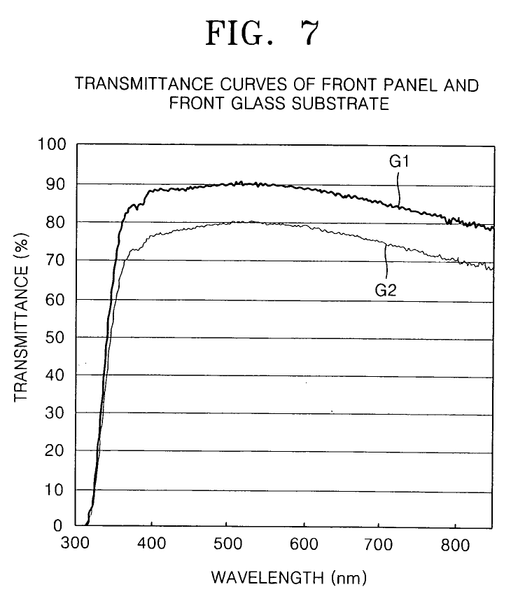

FIG. 7 is a graph showing a light transmittance of the front panel FP and a light transmittance of the front glass substrate 40. A first curve G1 represents the light transmittance of the front glass substrate 40 with a 2.8 mm thickness, and a second curve G2 represents the light transmittance of the front panel FP.

Referring to the first and second curves G1 and G2, the front panel FP has a transmittance of about 31% with respect to 337 nm-wavelength UV rays (hereinafter, referred to as first UV rays), a transmittance of about 66% with respect to 358 nm-wavelength UV rays (hereinafter, referred to as second UV rays), and a transmittance of about 73% with respect to 381 nm-wavelength UV rays (hereinafter, referred to as third UV rays). Accordingly, it can be known that when the N₂ gas is used as the source gas, at least 31% of the UV rays emitted from the plasma forming area PA in the discharge cell C pass through the front panel FP.

This fact can be summarized as in Table 1.

TABLE 1

| Wavelength (nm) | Transmittance (%) |
|---|---|
| 337 | 31 |
| 358 | 66 |
| 381 | 73 |

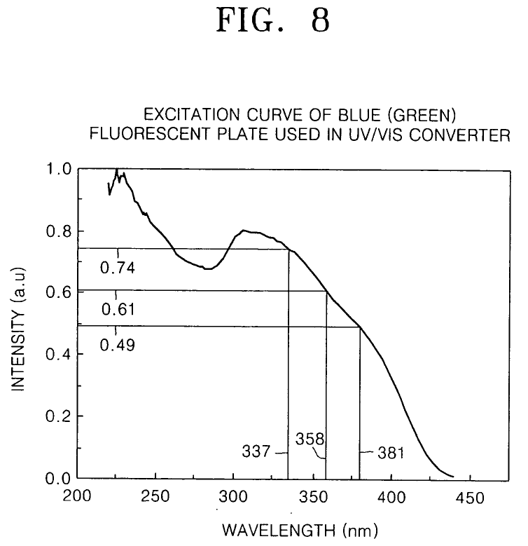

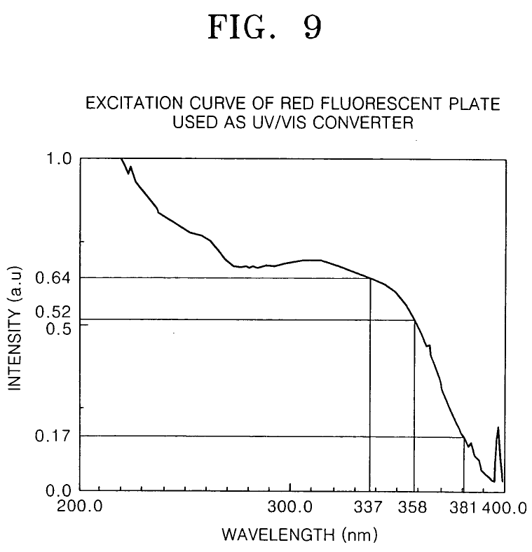

Hereinafter, excitation intensities of the first, second, and third fluorescent plates 70a, 70b, and 70c upon receipt of the first, second, and third UV rays transmitted by the front panel FP will be described with reference to FIGS. 8 and 9. FIG. 8 shows an excitation curve of the second (third) fluorescent plate 70b (70c) excited by UV rays.

Referring to FIG. 8, when the second (third) fluorescent plate 70b (70c) receives the first, second, and third UV rays, they excite 74%, 61%, and 49%, respectively, of the second (third) fluorescent plate 70b (70c).

Referring to FIG. 9, excitation intensities of the first fluorescent plate 70a are 64%, 52%, and 17% with respect to the first, second, and third UV rays, respectively.

Because the first, second, and third fluorescent plates 70a, 70b, and 70c emit visible rays during stabilization after excitation, the excitation intensities of the first, second, and third fluorescent plates 70a, 70b, and 70c directly relate to the rates at which the first, second, and third UV rays are converted into visible rays by the first, second, and third fluorescent plates 70a, 70b, and 70c.

As described above, since the optical converter 70 including the first, second, and third fluorescent plates 70a, 70b, and 70c converts the UV rays transmitted by the front panel FP into visible rays, the overall amount of light that is emitted from the PDP and reaches a user is a sum of the visible rays (hereinafter, referred to as first visible rays) emitted from the first, second, and third fluorescent layers 68a, 68b, and 68c and the visible rays (hereinafter, referred to as second visible rays) emitted by the first, second, and third fluorescent plates 70a, 70b, and 70c. In other words, the PDP according to the present invention enables a greatly increased amount of visible light to reach a user, as compared to conventional PDPs in which only the first visible rays reach to a user. As a result, the luminance of the PDP according to the present invention is increased.

Some of the first visible rays are lost while passing through the optical converter 70 installed in front of the front panel FP. Hence, the number of first visible rays transmitted by the optical converter 70 measures smaller than the number of first visible rays measured when the optical converter 70 is not installed. Thus, it is preferable that the number of second visible rays emitted from the optical converter 70 is greater than the number of first visible rays lost by the optical converter 70.

As described above, because the optical converter 70 relates to both the loss of the first visible rays and the emission of the second visible rays, the optical converter 70 preferably has a physical property (e.g., a thickness) that enables to increase the overall amount of light that is emitted from a PDP and reaches a user as compared to conventional PDPs.

The amount of first visible rays lost by the optical converter 70 can be ascertained by referring to the transmittance of the first visible rays with respect to the optical converter 70. The range of an appropriate thickness of the optical converter 70 is also determined by referring to the transmittance of the first visible rays with respect to the optical converter 70.

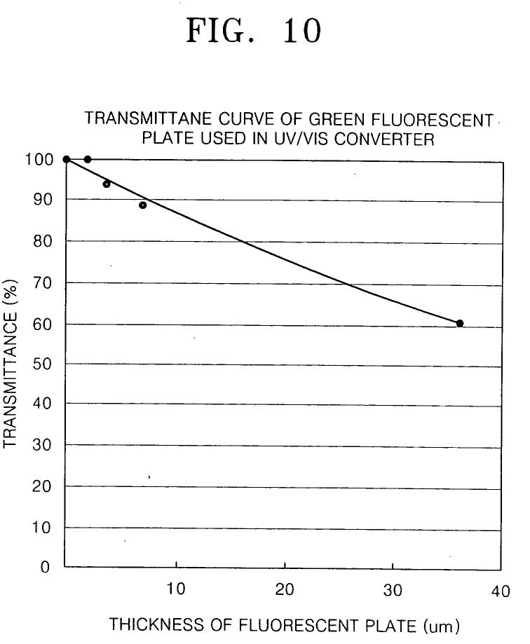

To be more specific, FIG. 10 shows a transmittance of G rays versus the thickness of the second fluorescent plate 70b. Although transmittance variations (not shown) of R and B rays according to the thicknesses of the first and third fluorescent plates 70a and 70c, respectively, are similar to the transmittance variation of G visible rays of FIG. 10, they are slightly different in transmittance value. Table 2 shows the tendency of transmission variations of the R, G, and B rays according to the thickness of each of the first, second, and third fluorescent plates 70a, 70b, and 70c.

| Thickness (μm) of | Transmittance |
|---|---|
| each of first, second, | (%) of each of R, |
| and third fluorescent plates | G, and B rays |
| 0 | 100 |
| 2 | 97 |
| 4 | 95 |
| 6 | 92 |
| 8 | 89 |
| 10 | 87 |
| 15 | 81 |
| 20 | 76 |

Referring to FIG. 10 and Table 2, it can be seen that the tendency of the transmittance variations of the R, G, and B rays with respect to the first, second, and third fluorescent plates 70a, 70b, and 70c is equal.

<Thickness Range of the Third Fluorescent Plate 70c>

Since the luminance of B rays among the first visible rays transmitted by the front panel FP is 76.8 cd/m², and the luminance of B rays among the second visible rays is 30.9 cd/m², the overall luminance of the B rays detected in front of the optical converter 70 must be greater than 76.8 cd/m², which is the luminance of the B rays among the first visible rays transmitted by the front panel FP. This condition is hereinafter referred to as a third condition. The overall luminance of the B light in front of the optical converter 70 is given by Inequality 1:

76.8 cd/m²<30.9 cd/m²+T3×76.8 cd/m² (1)

wherein T3 denotes a transmittance of the B rays among the first visible rays with respect to the third fluorescent plate 70c. The transmittance T3 is hereinafter referred to as a third transmittance. The third transmittance T3 satisfies the third condition and is obtained from Inequality 1.

The third transmittance T3 is given by Inequality 2:

T3>60% (2)

Preferably, the thickness of the third fluorescent plate 70c is less than 37 μm. In other words, the thickness (t) of the third fluorescent plate 70c is given as 0 μm<t<37 μm, preferably, 5 μm≦t<37 μm.

<Thickness Range of the Second Fluorescent Plate 70b>

Since the luminance of G rays among the first visible rays transmitted by the front panel FP is 78.8 cd/m², and the luminance of G rays among the second visible rays is 30.9 cd/m² like the luminance of B rays among the second visible rays, the overall luminance of G rays detected in front of the optical converter 70 must be greater than 78.8 cd/m², which is the luminance of G rays among the first visible rays transmitted by the front panel FP. This condition is hereinafter referred to as a second condition. The overall luminance of the G rays detected in front of the optical converter 70 is given by Inequality 3:

78.8 cd/m²<30.9 cd/m²+T2×78.8 cd/m² (3)

wherein T2 denotes a transmittance of the G rays among the first visible rays with respect to the second fluorescent plate 70b. The transmittance T2 is hereinafter referred to as a second transmittance. The second transmittance T2 satisfies the second condition and is obtained from Inequality 3.

The second transmittance T2 is given by Inequality 4:

T2>61% (4)

Referring to Inequality 4 and FIG. 10 showing the second transmittance T3 versus the thickness of the second fluorescent plate 70b, the thickness of the second fluorescent plate 70b is preferably less than 36 μm. In other words, the thickness (t) of the second fluorescent plate 70b is given as 0 μm<t<36 μm, preferably, 5 μm≦t<36 μm.

As described above, because the thickness ranges of the second and third fluorescent plates 70b and 70c are almost the same, the second and third fluorescent plates 70b and 70c preferably have the same thickness.

<Thickness Range of the First Fluorescent Plate 70a>

Since the luminance of R rays among the first visible rays transmitted by the front panel FP is 60.1 cd/m², and the luminance of R rays among the second visible rays is 22.8 cd/m², the overall luminance of R rays detected in front of the optical converter 70 must be greater than 60.1 cd/m², which is the luminance of R rays among the first visible rays transmitted by the front panel FP. This condition is hereinafter referred to as a first condition. The overall luminance of R rays existing in front of the optical converter 70 is given by Inequality 5:

60.1 cd/m²<22.8 cd/m²+T1×60.1 cd/m² (5)

wherein T1 denotes a transmittance of the R rays among the first visible rays with respect to the first fluorescent plate 70a. The transmittance T1 is hereinafter referred to as a first transmittance. The first transmittance T1 satisfies the first condition and is obtained from Inequality 5.

The first transmittance T1 is given by Inequality 6:

T1>62% (6)

The thickness of the first fluorescent plate 70a is preferably less than 35 μm in order to satisfy Inequality 6. In other words, the thickness (t) of the first fluorescent plate 70a is given as 0 μm<t<35 μm, preferably, 5 μm≦t<35 μm.

As described above, the thicknesses of the first, second, and third fluorescent plates 70a, 70b, and 70c must be thinner than 35 μm, 36 μm, and 37 μm, respectively, in order to make the overall luminance of light detected in front of the optical converter 70 be greater than the luminance of light transmitted by the front panel FP. Accordingly, the thicknesses of the first, second, and third fluorescent plates 70a, 70b, and 70c may be different, but are preferably set to be equal to one another in consideration of a PDP manufacturing process and the like. In other words, preferably, the first, second, and third fluorescent plates 70a, 70b, and 70c have an identical thickness that is less than 35 μm.

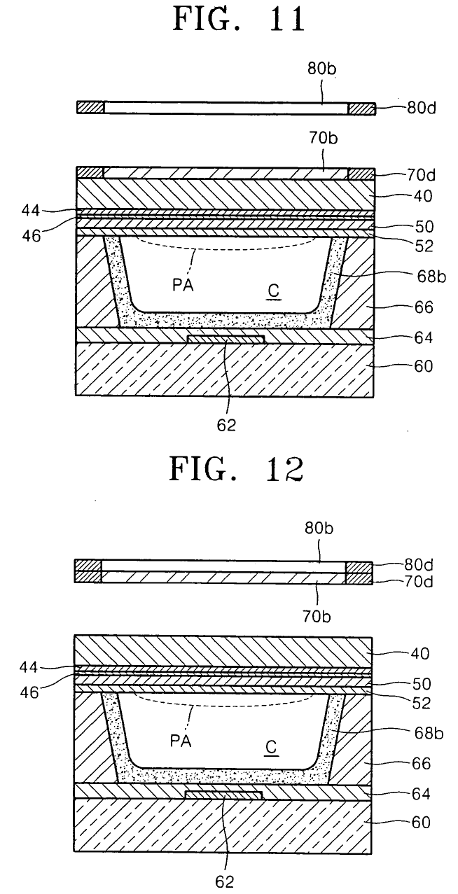

Modifications of the PDP according to an embodiment of the present invention of FIG. 4 will now be described with reference to FIGS. 11 and 12.

To be more specific, although the optical converter 70 in the PDP of FIG. 4 is provided between the front panel FP and the filter set 80 as shown in FIG. 5, the optical converter 70 may be attached to the front surface of the front panel FP, that is, the first side of the front glass substrate 40, as shown in FIG. 11. Alternatively, as shown in FIG. 12, the optical converter 70 may be attached to a surface of the filter set 80 that faces the first side of the front glass substrate 40.

As described above, when the optical converter 70 is attached to the filter set 80 or the first side of the front glass substrate 40, the optical converter 70 may be a film or powder.

Although not shown in the drawings, instead of the optical converter 70, the filter set 80 itself may be used as a converter for converting UV rays into visible rays. In other words, the filter set 80 can be constructed so as to perform its unique function, that is, an interception of UV rays, EMI, and the like, and also to convert the UV rays transmitted by the front panel FP into visible rays. The thus-constructed filter set 80 may be attached to the front panel FP.

As described above, a PDP according to the present invention includes an optical converter which is installed between a front panel and a filter set to convert received UV rays into visible rays. Hence, the overall amount or luminance of light detected in front of the optical converter is greater than when no optical converters are installed. Also, the PDP according to the present invention can increase the efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, one of skill in the art may incorporate the optical converter 70 with the filter set 80 instead of attaching the former to the latter. Also, one of skill in the art may form the optical converter 70 with a plurality of thin layers isolated from each other at predetermined intervals while keeping the thickness set out in the embodiment, instead of a single layer.

What is claimed is:

1. A plasma display panel including a front panel, a rear panel, and a filter set installed in front of the front panel, the plasma display panel comprising an optical converter installed between the front panel and the filter set, converting ultraviolet rays emitted from the front panel into visible rays.

2. The plasma display panel of claim 1, wherein the optical converter is attached to a front surface of the front panel.

3. The plasma display panel of claim 1, wherein the optical converter is attached to the back of the filter set.

4. The plasma display panel of claim 1, wherein the optical converter is a fluorescent plate having a predetermined thickness.

5. The plasma display panel of claim 4, wherein the fluorescent plate is formed of a fluorescent material that is able to convert ultraviolet rays with a wavelength of more than 330 nm into visible rays.

6. The plasma display panel of claim 4, wherein the fluorescent plate has a thickness that enables the amount of visible rays emitted from the front panel to be greater than the amount of visible rays lost while passing through the fluorescent plate.

7. The plasma display panel of claim 6, wherein the fluorescent plate is formed by combining red, green, and blue fluorescent plates that emit red, green, and blue visible rays, respectively, into which the ultraviolet rays are converted.

8. The plasma display panel of claim 6, wherein when the thickness of the fluorescent plate is t, the fluorescent plate has a uniform thickness in the range of 0 μm<t<35 μm.

9. The plasma display panel of claim 7, wherein when the thickness of the fluorescent plate is t, the thickness of the red fluorescent plate is in the range of 0 μm<t<35 μm, the thickness of the green fluorescent plate is in the range of 0 μm<t<36 μm, and the thickness of the blue fluorescent plate is in the range of 0 μm<t<37 μm.

10. The plasma display panel of claim 7, wherein the red fluorescent plate is an Y₂O₂S:Eu plate, and the green and blue fluorescent plates are BAM plates.

11. The plasma display panel of claim 5, wherein the fluorescent material is an organic photo-luminescent material.

12. The plasma display panel of claim 2, wherein the optical converter is a fluorescent film.

13. The plasma display panel of claim 3, wherein the optical converter is a fluorescent film.

14. The plasma display panel of claim 1, wherein a plasma source gas that emits ultraviolet rays with a wavelength of more then 330 nm exists in a discharge region between the front and rear panels, and a side of the rear panel that is exposed to the discharge region is covered with a fluorescent film that is excited by the ultraviolet rays and emits visible rays.

15. The plasma display panel of claim 14, wherein the fluorescent plate is one selected from a Y₂O₂S:Eu plate for emitting red light, a BAM plate for emitting green light, and a BAM plate for emitting blue light.
